(19) United States
(12) Patent Application Publication
(10) Pub. No.: US 2004/0005115 A1
(43) Pub. Date: Jan. 8, 2004

(54) Optoelectronic add/drop multiplexer

(76) Inventors: Xin Simon Luo, Monterey Park, CA (US); Nghia Kha, Baldwin Park, CA (US)

Correspondence Address: CHRISTIE, PARKER & HALE, LLP, 350 WEST COLORADO BOULEVARD, SUITE 500, PASADENA, CA, 91105, US

(21) Appl. No.: 10/187,824

(22) Filed: Jul. 2, 2002

(51) Int. Cl. G02B 6/293; G02B 6/26

(52) U.S. Cl. 385/24; 385/47

(57) ABSTRACT

An optoelectronic add/drop multiplexer is disclosed having an optically transmissive block optically coupled to an incoming WDM signal having a two or more incoming optical signals. The add/drop multiplexer further includes one or more drop bandpass filters adapted to remove one or more incoming optical signals from a multi-channel signal flow in a first direction within the optically transmissive block and one or more add bandpass filters adapted to add one or more output optical signals to the multi-channel signal flow in a second direction within the optically transmissive block.

### FIELD OF THE INVENTION

The present invention generally relates to optical communications and more particularly relates to add/drop multiplexers for multiplexing and or demultiplexing WDM optical signals.

### BACKGROUND

In many applications, such as optical LANs, cable television subscriber systems, and telecommunications networks, there is a need to route one or more channels of a multiplexed optical signal to different destinations. Therefore, optical add-drop multiplexers are often employed at connector points, or nodes where two or more loops intersect in telecommunications networks in order to add/drop one or more of these channels.

In operation, one or more carrier wavelengths may be dropped at a node, one or more carrier wavelengths (which may be the same as, or different from those dropped from the trunk or ring) are added to the trunk or ring from another fiber of the branch and one or more carrier wavelengths pass through the node. Conventionally the incoming WDM signal is demultiplexed into its component carrier wavelengths with a prism or similar device, and each of the carrier wavelengths is routed to its desired destination. Therefore, pass through carrier wavelengths in the WDM signal are often unnecessarily demultiplexed and multiplexed into the pass through signal requiring the use of additional optical components and increasing the complexity and cost of the device.

### SUMMARY OF THE INVENTION

In one aspect of the present invention an optoelectronic add/drop multiplexer having a bi-directional zig-zag optical pathway includes an optically transmissive block, one or more drop bandpass filters adapted to remove one or more incoming optical signals from the multi-channel signal flow in a first direction within the optically transmissive block and one or more add bandpass filters adapted to add one or more output optical signals to the multi-channel signal flow in a second direction within the optically transmissive block.

In another aspect of the present invention an optoelectronic add/drop multiplexer includes an optically transmissive block comprising an input surface for receiving an incoming multi-channel optical signal, reflecting means optically coupled to the input surface along a first zig-zag optical path for reversing direction of propagation of the incoming multi-channel optical signal and an output surface, optically coupled to the reflecting means along a second zigzag optical path for outputting the reversed multi-channel optical signal.

In a further aspect of the present invention an optical communication system includes a plurality of nodes that couple a plurality of access networks to a closed loop metropolitan access network, wherein at least one of the plurality of nodes comprises an optoelectronic add/drop multiplexer having an optically transmissive block and one or more drop bandpass filters adapted to remove one or more incoming optical signals from a multi-channel signal flow in a first direction within the optically transmissive block and one or more add bandpass filters adapted to add one or more output optical signal to the multi-channel signal flow in a second direction within the optically transmissive block a metropolitan network node coupling the closed loop metropolitan access network to a metropolitan network.

In a still further aspect of the present invention a method of communicating optical signals includes coupling an incoming WDM signal comprising a plurality of incoming optical signals at a plurality of wavelengths into an optically transmissive block, removing one or more of the plurality of incoming optical signals from the incoming WDM signal during propagation of the WDM signal in a first direction within the optically transmissive block, reversing direction of propagation of the incoming WDM signal and adding one or more output optical signals to the reversed WDM signal during propagation in the reverse direction.

### BRIEF DESCRIPTION OF THE DRAWINGS

These and other features, aspects, and advantages of the present invention will become better understood with regard to the following description, appended claims, and accompanying drawings, in which:

FIG. 1 is simplified schematic diagram of a metropolitan area network;

FIG. 2 is a simplified schematic diagram of an optoelectronic add/drop multiplexer for removing one or more incoming optical signals from an input multi-channel optical signal and for adding one or more output optical signals to the multi-channel optical signal and for passing undisturbed one or more optical signals in accordance with an exemplary embodiment of the present invention;

FIG. 3 is a cross section including the optical path of a optoelectronic add/drop multiplexer wherein incoming optical signals are removed by filters on a first surface of an optically transmissive block and output optical signals are added by filters on a second surface of the optically transmissive block in accordance with an exemplary embodiment of the present invention; and

FIG. 4 is a cross section including the optical path of another optoelectronic add/drop multiplexer wherein incoming optical signals are removed by filters during multi-channel signal flow in a forward direction and output optical signals are added by filters during multi-channel signal flow in a second direction in accordance with an exemplary embodiment of the present invention.

### DETAILED DESCRIPTION OF THE INVENTION

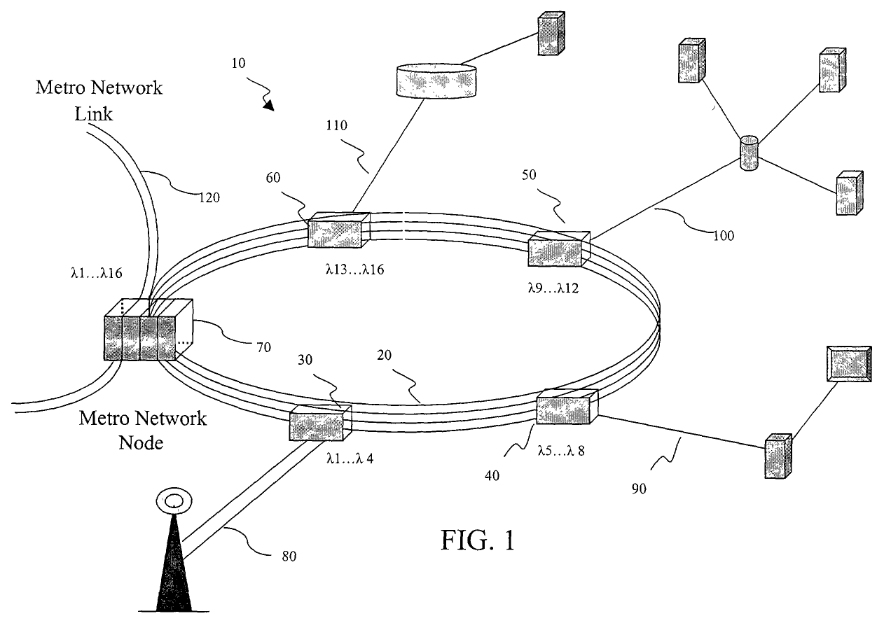

An exemplary embodiment of the present invention provides a bi-directional optoelectronic add/drop multiplexer. The described exemplary embodiment may be used to add or remove one or more wavelength channels at any of a variety of points along an optical fiber transmission path, without disturbing or disrupting the remaining wavelength channels, whether the optical transmission system is a long haul, metropolitan, or local system. However, the advantages of the present invention may be best demonstrated in the context of an exemplary application such as for example a metropolitan area network 10 as illustrated in the simplified block diagram of FIG. 1.

Metropolitan area networks typically have a ring or loop configuration 20 comprising a plurality of nodes 30, 40, 50, 60 and 70 coupling a plurality of access networks 80, 90, 100 and 110 to the continuous or looped optical path 20. In the described exemplary embodiment at least one optical add/drop element (not specifically shown) may be associated with each node 30-70 along the ring to provide for the addition and extraction of one or more optical signals at a particular wavelength to and from the ring. In addition, in an exemplary embodiment, one of the nodes (e.g. 70 in this embodiment) along the ring may be a metropolitan network node having a plurality of associated add/drop elements for transmitting and receiving a corresponding plurality of optical signals at respective wavelengths to/from other nodes along the ring and for coupling the ring to a high level metropolitan core network 120.

An exemplary WDM system may comprise for example a sixteen channel multiplexed signal wherein each of the channels is preferably at a wavelength within a relatively narrow range about 1310 nm or 1550 nm where the absorption of most silica-based optical fibers is at a minimum. In an exemplary embodiment the wavelengths may be narrowly spaced, typically in the range of about 50-200 GHz, but sufficiently far apart to be separated by add/drop elements. In the described exemplary embodiment, each of the nodes along the ring may add/drop four of the sixteen channels without disrupting or processing the remaining twelve channels.

One of skill in the art will appreciate however, that the add/drop elements within each node may add or subtract a larger or smaller number of channels. In addition the plurality of nodes need not add/subtract an equal number of channels. Rather, the add/drop elements within the various nodes 30-70 may add/drop the same or a different number of channels than the other nodes connected along the ring. One of skill in the art will further appreciate that the present invention is not limited to systems having a particular number of multiplexed channels. Rather, the present invention may be used with DWDM, CWDM or WDM systems having any number of multiplexed channels. Therefore, the illustrated metropolitan access network is by way of example only and not by way of limitation.

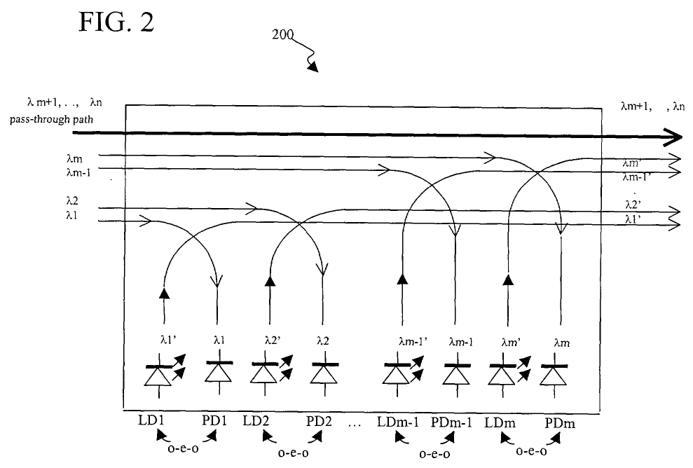

FIG. 2 is a simplified schematic diagram of an exemplary optical signal processor 200 coupled to an incoming optical signal comprising a plurality of wavelengths (n in the general case). In operation, an exemplary optoelectronic add/drop multiplexer may separate or drop one or more optical signals (m in the general case where m<n) at particular wavelengths from the incoming signal. The separated wavelengths can, for example, be directed to photodetectors (e.g. PD₁-PDₘ) in a receiver application, or to separate optical fibers in a wavelength routing application. The described exemplary optoelectronic add/drop multiplexer may also pass undisturbed one or more channels (m+1 to n in the general case) through the node and back onto to the ring.

Alternatively, in an exemplary optical/electronic/optical (o-e-o) bypass switch application, separated wavelengths may be received by photodetectors PD₁-PDₘ that convert the received optical signals λ1-λm to electronic signals. The electronic signals may be coupled to optoelectronic transmitters LD₁-LDₘ respectively for adding an optical signal at particular wavelengths λ₁′-λₘ′ back onto the ring. One of skill in the art will appreciate that λ₁′-λₘ′ may be different than or equal to wavelengths λ₁-λₘ.

Alternatively, photodetectors PD₁-PDₘ may be coupled to receiver electronics (not shown) for forwarding received signals to network devices coupled to the access networks 80-110 (see FIG. 1). In addition, optoelectronic transmitters LD₁-LDₘ may be separately coupled to drive electronics (not shown) that receive signals from network devices (not shown) coupled to the access network for transmission onto the ring at wavelengths λ₁′-λₘ′.

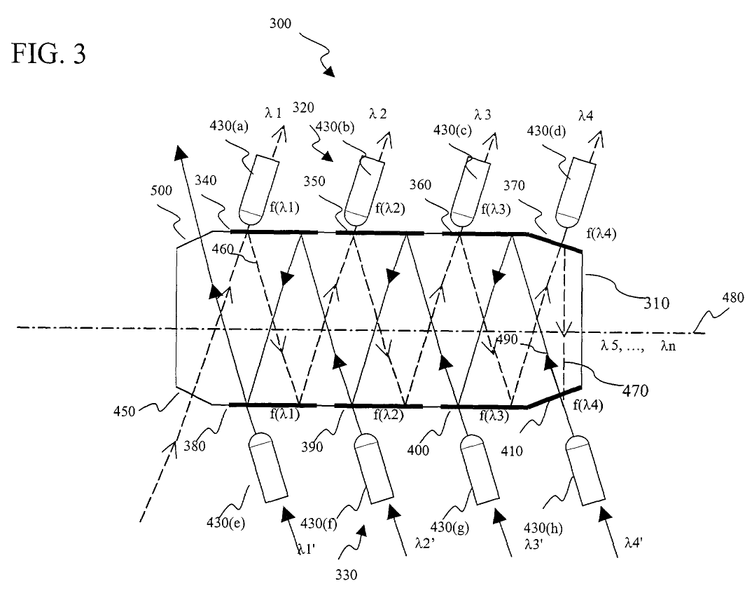

FIG. 3 is graphical illustration of an exemplary optoelectronic add/drop multiplexer including the optical path. In the described exemplary embodiment the add/drop multiplexer 300 may comprise an optical block 310 formed from optical quality glass, such as polished high purity fused silica (SiO₂) or other materials known in the art such as for example, molded optical grade plastic, GaAs, CaAlF₆, or the like.

In accordance with an exemplary embodiment, the optical block may comprise two, opposing surfaces 320 and 330. In the described exemplary embodiment a plurality of band-pass filters 340-370 and 380-410 may be formed at discrete location on surfaces 320 and 330 respectively. The described exemplary bandpass filters may comprise, multi-layer thin film interference filters, fiber Bragg gratings, diffraction gratings, arrayed waveguide gratings, discrete multiwavelength Fabry-Perot transmission filters, or the like.

In the described exemplary embodiment, the bandpass filters are spaced apart slightly from each other and may be coupled to surfaces 320 and 330 of optical block 310 in accordance with any one of a variety of known techniques. For example, the bandpass filter may be adhesively coupled to surfaces 320 and 330 of the optical block. Alternatively, interference filters may be deposited directly on surfaces 320 and 330 of the optical block by commercially known deposition techniques, such as ion assisted electron beam evaporation, ion beam sputtering, and reactive magnetron sputtering, etc.

In the described exemplary embodiment wavelengths of light that are in the pass band of the passband filters transmit through the filter and may be collected by collimating lens 430(a-h). In addition, wavelengths of light outside the pass band of the filters are reflected. In this manner, light is reflected from filter to filter down the device, and a single channel or band of channels may be removed from or introduced into the reflected signal through each filter.

For example, in one embodiment, bandpass filters may be symmetrically located on opposing surfaces 320 and 330 of the optical block. In the described exemplary embodiment filters 340 and 380 have a passband centered about a wavelength of λ₁, filters 350 and 390 have a passband centered about a wavelength of λ₂, filters 360 and 400 have a passband centered about a wavelength of λ₃ and filters 370 and 410 have a passband centered about a wavelength of λ₄.

In practice, wavelengths of light that are in the passband of the narrowband filters 340-370 transmit through the filter and may be collected by collimating lens 430 (a-d). In addition, filters 380-410 may be coupled to optoelectronic transmitters via collimating lenses 430(e-h) to add signals at wavelengths of λ₁′, λ₂′, λ₃′ and λ₄′ respectively. In the described exemplary embodiment λ₁′-λ₄′ may be equal to or different than λ₁-λ₄. In this manner, light is reflected from filter to filter with optical signals being removed as the multi-channel signal propagates in the forward direction by filters located on surface 320 and optical signals being added to the multi-channel signal as it propagates in the reverse direction through filters 380-410 located on surface 330.

For example, in operation a collimated incoming WDM signal, comprising a plurality of optical signals at wavelengths λ₁-λₙ, may be incident upon a sloped input surface 450 of the optical block at an angle in the range of about 80-100 degrees. In the described exemplary embodiment an antireflective coating may be included on the sloped input surface to increase transmission of the incoming signal into the optical block 300 where it impinges at an angle on bandpass filter 340 on surface 320.

In the described exemplary embodiment bandpass filter 340 may transmit optical wavelengths within a relatively narrow band around λ₁ that may be collected by collimating lens 430(a) and reflects other wavelengths (e.g. λ₂-λₙ in this embodiment). The reflected signal 460 comprising wavelengths λ₂-λₙ may impinge upon a second λ₁ band pass filter 380 on the opposing surface 330 of the optical block 300. In the described exemplary embodiment filter 380 redirects the signal to the λ₂ bandpass filter 350 on the opposing surface 320 of the optical block.

In the described exemplary embodiment bandpass filter 350 transmits optical waves centered within a relatively narrow band around λ₂ and reflects other wavelengths (e.g. λ₃-λₙ in this embodiment). The reflected signal may impinge upon a second λ₂ band pass filter 390 located on opposing surface 330 of the optical block. In the described exemplary embodiment filter 390 redirects the λ₃-λₙ signal to the λ₃ bandpass filter 360 on the opposing surface 320 of the optical block and so on through the series of filters, until all of the desired wavelengths (λ₁-λ₄ in this embodiment) have been transmitted through their respective bandpass filters and removed from the multi-channel signal flow.

In the described exemplary embodiment, the λ₄ bandpass filter 370 may be located on a swept portion of surface 320 to redirect signal 470 comprising wavelengths λ₅-λₙ to a second λ₄ bandpass filter 410 located on a swept portion of surface 330 that reverses the direction of propagation of the signal comprising wavelengths λ₅-λₙ. In addition, an optical signal at a wavelength of λ₄′ may be transmitted through filter 410 and added to the signal redirected by filter 410. In the described exemplary embodiment, the swept portions of surfaces 320 and 330 may be symmetrically swept about the centerline 480 of the optical block 300.

In the described exemplary embodiment signal 490 comprising wavelengths λ₄′-λₙ is incident upon and reflected by the λ₃ band pass filter 360 to the λ₃ band pass filter 400 located on surface 330 of the optical block. In the described exemplary embodiment an optical signal at a wavelength of λ₃′ may be transmitted through filter 400 and added to the signal redirected by filter 400. The combined signal comprising wavelengths λ₃′-λₙ is incident upon and reflected by the λ₂ band pass filter 350 to the λ₂ band pass filter 390 located on surface 330 of the optical block. A signal at a wavelength of λ₂′ may be added to the signal redirected by filter 390. The combined signal comprising wavelengths λ₂′-λₙ is incident upon and reflected by the λ₁ band pass filter 340 to the λ₁ bandpass filter 380 located on surface 330 of the optical block. In the described exemplary embodiment an optical signal at a wavelength of λ₁′ may be transmitted through filter 380 and added to the signal redirected by filter 380.

In an exemplary embodiment of the present invention the combined signal comprising wavelengths λ₁′-λₙ may be output through a sloped surface 500 opposite input surface 450 to a collimating optic (not shown) for injection back onto the ring. In the described exemplary embodiment one or more optical signals (in this embodiment at wavelengths λ₅-λₙ) may propagate undisturbed through the optoelectronic add/drop multiplexer and be injected back onto the ring with a plurality of added optical signals in this case at wavelengths λ₁′-λ₄′.

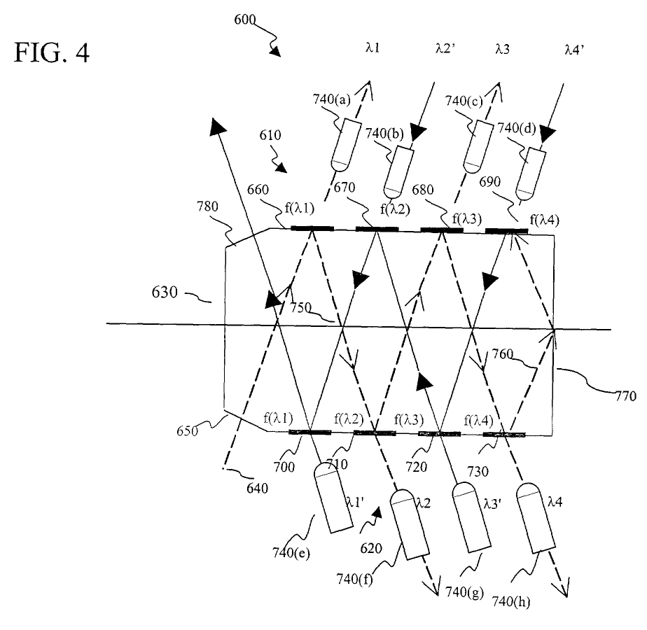

One of skill in the art will appreciate that the present invention is not limited to the disclosed implementation. Rather a variety of implementations may be utilized to provide bi-directional multiplexing and demultiplexing of WDM signals. For example, FIG. 4 graphically illustrates another optoelectronic add/drop multiplexer 600 where optical signals are added to or dropped from the multi-channel flow by a series of bandpass filters located on first and second surfaces 610 and 620 of an optical block 630.

For example, in one embodiment a collimated incoming WDM signal 640, comprising a plurality of optical signals at wavelengths λ₁-λₙ, is incident upon a sloped input surface 650 of the optical block 630 at an angle in the range of about 80-100 degrees. In the described exemplary embodiment an anti-reflective coating may be included on the sloped input surface to increase transmission of the incoming signal into the optical block.

In this embodiment the multi-channel signal again traverses a bidirectional, zig-zag optical path. In accordance with an exemplary embodiment optical signals may be dropped from the multi-channel flow in the forward direction of propagation and optical signals may be added to the multi-channel flow in the reverse direction of propagation.

For example, in one embodiment the incoming signal may first impinge at an angle on a λ₁ bandpass filter 660 on surface 610. In the described exemplary embodiment bandpass filter 660 may transmit optical wavelengths within a relatively narrow band around λ₁ that may be collected by collimating lens 740(a) and reflects other wavelengths (e.g. λ₂-λₙ in this embodiment). The reflected signal 750 comprising wavelengths λ₂-λₙ may impinge upon a λ₂ band pass filter 710 on the opposing surface 620 of the optical block 630. In the described exemplary embodiment filter 620 transmits optical wavelengths within a relatively narrow band around λ₂ that may be collected by collimating lens 740(f) and reflects other wavelengths (e.g. λ₃-λₙ in this embodiment).

In this manner the multi-channel optical wave propagates down the optical block 630 in a first or forward direction until all of the desired wavelengths (λ₁-λ₄ in this embodiment) have been transmitted through their respective bandpass filters and removed from multi-channel signal flow. The separated wavelengths can, for example, be directed to photodetectors in a receiver application, or to separate optical fibers in a wavelength routing application.

In the described exemplary embodiment, the λ₄ bandpass filter 730 forwards a signal 760 comprising wavelengths λ₅-λₙ to a reflecting surface 770. In one embodiment the angle of incidence on the reflecting surface may be greater than the critical angle so that signal 760 is totally reflected. Alternatively, a reflective coating, such as, for example, silver, gold, chromium, aluminum or tin may be deposited on the outboard reflecting surface to ensure total internal reflection.

In the described exemplary embodiment the reflecting surface reverses the direction of propagation of the signal 760 comprising wavelengths λ₅-λₙ. The reversed signal is incident upon and reflected by a second λ₄ bandpass filter 690. In the described exemplary embodiment an optical signal at a wavelength of λ₄′ may be transmitted through filter 690 and added to the signal redirected by filter 690. The combined signal comprising wavelengths λ₄′-λₙ is incident upon and reflected by the λ₃ band pass filter 720. In the described exemplary embodiment an optical signal at a wavelength of λ₃′ may be transmitted through filter 720 and added to the signal redirected by filter 720.

In this manner the multi-channel optical wave propagates down the optoelectronic in the reverse direction until all of the desired wavelengths (λ₁′-λ₄′ in this embodiment) have been added to the multi-channel signal that may exit through a sloped surface 780 opposite input surface 650 to a collimating optic (not shown) for injection back onto the ring. In the described exemplary embodiment one or more optical signals (in this embodiment at wavelengths λ₅-λₙ) may propagate undisturbed through the optoelectronic add/drop multiplexer and be injected back onto the ring with a plurality of added optical signals, in this case at wavelengths λ₁′-λ₄′.

Although exemplary embodiments of the present invention have been described, they should not be construed to limit the scope of the present invention. Those skilled in the art will understand that various modifications may be made to the described embodiments. Further, the invention described herein will itself suggest to those skilled in the various arts, alternate embodiments and solutions to other tasks and adaptations for other applications. It is the applicants intention to cover by claims all such uses of the invention and those changes and modifications which could be made to the embodiments of the invention herein chosen for the purpose of disclosure without departing from the spirit and scope of the invention.

What is claimed is:

1. An optoelectronic add/drop multiplexer having a bidirectional zig-zag optical pathway, comprising:
an optically transmissive block;
one or more drop bandpass filters adapted to remove one or more incoming optical signals from a multi-channel signal flow in a first direction within said optically transmissive block; and
one or more add bandpass filters adapted to add one or more output optical signals to said multi-channel signal flow in a second direction within said optically transmissive block.

2. The optoelectronic add/drop multiplexer of claim 1 wherein said drop bandpass filters are on a first side of a centerline of the optically transmissive block and wherein said add bandpass filters are on a second side of the centerline of the optically transmissive block.

3. The optoelectronic add/drop multiplexer of claim 1 wherein at least a portion of said drop bandpass filters and add bandpass filters are positioned on a common surface of said optically transmissive block.

4. The optoelectronic add/drop multiplexer of claim 1 wherein said optically transmissive block comprises an input surface optically coupled to an input collimating optic for receiving an incoming multi-channel optical signal.

5. The optoelectronic add/drop multiplexer of claim 4 wherein said optically transmissive block further comprises an output surface optically coupled to an output collimating optic for outputting a multi-channel optical signal.

6. The optoelectronic add/drop multiplexer of claim 5 wherein said optically transmissive block further comprises a reflecting surface that reverses direction of propagation of said multi-channel signal flow from said first direction to said second direction.

7. The optoelectronic add/drop multiplexer of claim 5 wherein said optically transmissive block further comprises means for reversing direction of propagation of said multi-channel signal flow from said first direction to said second direction.

8. The optoelectronic add/drop multiplexer of claim 1 further comprising one or more drop collimating optics coupled to said drop bandpass filters for receiving dropped optical signals transmitted by said drop bandpass filters.

9. The optoelectronic add/drop multiplexer of claim 1 further comprising one or more add collimating optics coupled to said add bandpass filters for passing a collimated optical signal to said add bandpass filters for addition to said multi-channel signal flow.

10. An optoelectronic add/drop multiplexer comprising:
an optically transmissive block comprising an input surface for receiving an incoming multi-channel optical signal, reflecting means optically coupled to said input surface along a first zig-zag optical path for reversing direction of propagation of said incoming multi-channel optical signal and an output surface, optically coupled to said reflecting means along a second zig-zag optical path for outputting said reversed multi-channel optical signal.

11. The optoelectronic add/drop multiplexer of claim 10 further comprising one or more drop bandpass filters that remove one or more input optical signals from said incoming multi-channel optical signal along said first multi-bounce zig-zag optical path.

12. The optoelectronic add/drop multiplexer of claim 11 further comprising one or more add bandpass filters that add one or more output optical signals from said reversed multi-channel optical signal along said second multi-bounce zig-zag optical path.

13. The optoelectronic add/drop multiplexer of claim 12 wherein said drop bandpass filters are positioned on a first surface of said optically transmissive block and said add bandpass filters are positioned on a second surface of said optically transmissive block which is separated from and substantially parallel to the first surface.

14. The optoelectronic add/drop multiplexer of claim 12 wherein at least a portion of said drop bandpass filters and add bandpass filters are positioned on a common surface of said optically transmissive block.

15. An optical communication system, comprising:
a plurality of nodes for coupling a plurality of access networks to a closed loop metropolitan access network, wherein at least one of said plurality of nodes comprises an optoelectronic add/drop multiplexer having an optically transmissive block and one or more drop bandpass filters adapted to remove one or more incoming optical signals from a multi-channel signal flow in a first direction within said optically transmissive block and one or more add bandpass filters adapted to add one or more output optical signals to said multi-channel signal flow in a second direction within said optically transmissive block; and
a metropolitan network node coupling said closed loop metropolitan access network to a metropolitan network.

16. The optoelectronic add/drop multiplexer of claim 15 wherein said optically transmissive block comprises an input surface optically coupled to an input collimating optic for receiving an incoming multi-channel optical signal.

17. The optoelectronic add/drop multiplexer of claim 16 wherein said optically transmissive block further comprises an output surface optically coupled to an output collimating optic for outputting a multi-channel optical signal.

18. The optoelectronic add/drop multiplexer of claim 17 wherein said optically transmissive block further comprises a reflecting surface that reverses direction of propagation of said multi-channel signal flow from said first direction to said second direction.

19. The optoelectronic add/drop multiplexer of claim 17 wherein said optically transmissive block further comprises means for reversing direction of propagation of said multi-channel signal flow from said first direction to said second direction.

20. A method of communicating optical signals, comprising:
coupling an incoming WDM signal comprising a plurality of incoming optical signals at a plurality of wavelengths into an optically transmissive block;
removing one or more of said plurality of incoming optical signals from said incoming WDM signal during propagation of said WDM signal in a first direction within said optically transmissive block;
reversing direction of propagation of said incoming WDM signal; and
adding one or more output optical signals to said reversed WDM signal during propagation in said reversed direction.
